(19) United States
(12) Patent Application Publication
(10) Pub. No.: US 2017/0024526 A1
(43) Pub. Date: Jan. 26, 2017

(54) METHOD FOR MANAGING REIMBURSEMENTS FOR PREVIOUSLY NON DATABASE ALLERGENS

(71) Applicant: ROCA MEDICAL LTD., London (GB)

(72) Inventors: JAMES STRADER, AUSTIN, TX (US); JOVAN HUTTON PULITZER, FRISCO, TX (US)

(21) Appl. No.: 15/171,920

(22) Filed: Jun. 2, 2016

Related U.S. Application Data
(60) Provisional application No. 62/169,787, filed on Jun. 2, 2015.
(60) Provisional application No. 62/169,785, filed on Jun. 2, 2015.

(51) Int. Cl. G06F 19/00

(52) U.S. Cl. CPC G06F 19/328; G06F 19/326

(57) ABSTRACT

The present disclosure provides a method for adjudicating reimbursement for allergens between a pharmacist and a reimbursing entity including obtaining at a central control center National Drug Codes (NDC's) for a plurality of allergens, determining by the central control center an Average Wholesale Price (AWP) for each of the allergens associated with each of the NDC's, accessing a third-party database accessible by a pharmacist and determining if any of the NDC's in the central control database are contained within the third-party database, and creating an adjudicating database at the central control center having defined benefits associated with reimbursable entities for each of the NDC's stored in the third-party database and in the central control database, wherein a pharmacist can access this information by accessing a particular NDC in the third-party database to obtain information and enter a claim.

### CROSS-REFERENCE TO RELATED APPLICATIONS

This application claims the benefit of U.S. Provisional Application No. 62/169,787, filed on Jun. 2, 2015, entitled METHOD FOR REPURPOSING NDC CODES IN A PHARMACEUTICAL DATABASE FOR ALLERGENS (Atty. Dkt. No. RCMD-32681), and U.S. Provisional Application No. 62/169,785, filed on Jun. 2, 2015, entitled METHOD FOR MANAGING REIMBURSEMENTS FOR PREVIOUSLY NON DATABASE ALLERGENS (Atty. Dkt. No. RCMD-32682). U.S. Provisional Application Nos. 62/169,787 and 62/169,785 are incorporated by reference in their entirety.

### TECHNICAL FIELD

The following disclosure relates to repurposing an existing database related to the pharmaceutical industry and reimbursement for such things as allergens that are not currently supported in the database.

### BACKGROUND

Currently, allergens are not readily reimbursed when received from a pharmacist for the simple reason that the National Drug Code (NDC) code is not included in the database to which the pharmacist has access. Without an NDC code in the database, the pharmacist cannot access that information. By not being able to access information, the pharmacist cannot interface with a benefits provider for reimbursements nor can they have access to the Average Wholesale Price (AWP), which is the benchmark that has been used for many years for pricing and reimbursement of prescription drugs for both government and private payers. Initially, this AWP was intended to represent the average price that wholesalers used to sell medications to providers, such as physicians, pharmacies, and other customers. However, the AWP is not a true representation of actual market prices for either generic or brand drug products. AWP has often been compared to the “list price” or “sticker price”, meaning it is an elevated drug price that is rarely what is actually paid. AWP is not a government-regulated figure, does not include buyer volume discounts or rebates often involved in prescription drug sales, and is subject to fraudulent manipulation by manufacturers or even wholesalers. As such, the AWP, while used throughout the industry, is a controversial pricing benchmark.

The AWP may be determined by several different methods. The drug manufacturer may report the AWP to the individual publisher of drug pricing data, such as Medi-Span. The AWP may also be calculated by the publisher based upon a mark-up specified by the manufacturer that is applied to the wholesale acquisition cost (WAC) or direct price (DIRP). The WAC is the manufacturer's list price of the drug when sold to the wholesaler, while the DIRP is the manufacturer's list price when sold to non-wholesalers. Typically a 20% mark-up is applied to the manufacturer-supplied WAC or DIRP, which results in the AWP figure.

The publishers then in turn sell these published AWPs to government, private insurance, and other buyers of prescription drugs, who use these data tables to determine reimbursement and retail prices. Because AWP is a component of the formulas used to determine reimbursement, elevated AWP numbers can drastically increase the dollar amount that government, private insurance programs, and consumers with coinsurance must pay.

Pharmacies typically buy drugs from a wholesaler and then sell them to the public. Many patients have coinsurance or copayments, where they only pay for a portion of their prescription cost. The insurance company then pays the rest of the cost (the reimbursement) to the pharmacy. Insurance companies include prescription benefit manager (PBM), health maintenance organization (HMO) or government programs, such as Medicaid or Medicare Part B or D. In addition, the pharmacy receives a dispensing fee for filling the prescription. Fees are, for example, set between $3 to $5 per prescription, but may vary by state.

Reimbursements are based on AWPs. However, pharmacies purchase drugs based on the WAC. The difference between the WAC (what the pharmacy actually paid for the drug) and the reimbursement from insurance (based on AWP) is known as the spread, and equates to the profit that the pharmacy receives.

Market pricing on brand drugs tend to be about 16.6 percent less than the AWP. However, the relation of AWP to generic pricing is not clear. Older generics tend to have a large spread between the AWP and WAC, which in turn gives a large spread, and higher profit margins for the pharmacy or other provider of the drug. Many payers, such as PBMS or HMOs, will determine a maximum allowable cost (MAC) pricing on generics to avoid being overcharged. Newer generic products, compared to older generics, may not have as favorable of a spread, thus the need for MAC.

Collusion between AWP publishers and wholesalers to artificially inflate the AWP, and in turn increase the spread, has led to court cases in the U.S. In these cases, it was alleged that increasing the spread benefited the wholesaler because customers (pharmacies and large institutions) were more likely to buy from them than a competing wholesaler where the spread was not as desirable. The publisher of AWPs profited because pharmacies were more likely to buy the pricing lists from the publisher that noted the higher AWPs used in calculating the spread, than to buy them from other publishers with lower AWPs. Due to this pricing fraud, many payers, including government payers, are no longer using AWP for pricing, and are switching to other more transparent pricing benchmarks, such as WAC or AMP (average manufacturers price). However, AWP may still be found in use in the U.S. because it has been the standard for decades.

However, in order for a pharmacist to access the AWP and to be able to interface with benefits providers, the product associated with an NDC must be in the database. Currently, allergens are on item that does not exist in the database.

### SUMMARY

In one embodiment, the present disclosure provides a method for adjudicating reimbursement for allergens between a pharmacist and a reimbursing entity. The method includes obtaining at a central control center National Drug Codes (NDC's) for a plurality of allergens, each of the allergens being a single dose single use allergen for a patient and each NDC uniquely identifying that particular allergen as to its manufacture, the particular allergen, the packaging and the dosage, and further obtaining information as to a description of the particular allergen, dosage and manufacture, determining by the central control center an Average Wholesale Price (AWP) for each of the allergens associated with each of the NDC's, and storing in a central control database the obtained NDC's in association with an associated AWP and associated information for the allergen. The method further includes accessing a third-party database accessible by a pharmacist and determining if any of the NDC's in the central control database are contained within the third-party database and, if not, transferring the associated NDC's not in the third-party database and that exist in the central control database for each of the allergens to the third-party database in association with the AWP and associated information for each of the allergens for each of the NDC's and uniquely associating each of the NDC's in the third-party database to the central control center for adjudication information. The method further includes creating an adjudicating database at the central control center having defined benefits associated with reimbursable entities for each of the NDC's stored in the third-party database and in the central control database, wherein a pharmacist can access this information by accessing a particular NDC in the third-party database to obtain information regarding reimbursable benefits from the central control center and enter a claim with the central control center for adjudication and wherein the central control center is able to process any claim made by the pharmacist and reimburse the pharmacist accordingly.

### BRIEF DESCRIPTION OF THE DRAWINGS

For a more complete understanding, reference is now made to the following description taken in conjunction with the accompanying Drawings in which:

FIG. 1 illustrates a general diagrammatic view of the overall interface of basic databases;

FIG. 1A illustrates an NDA code;

FIG. 2 illustrates a diagrammatic view of a database that is populated by a central control system;

FIG. 3 illustrates a flow chart for the operation at the central control system for receiving NDCs from the manufacturer;

FIG. 4 illustrates a flow chart for the operation of populating third-party database by the central control system; and

FIG. 5 illustrates a flow chart for the operation at the pharmaceutical location; and

FIG. 6 illustrates a flow chart for the overall generation of the AWP and the interface with the benefit providers.

### DETAILED DESCRIPTION

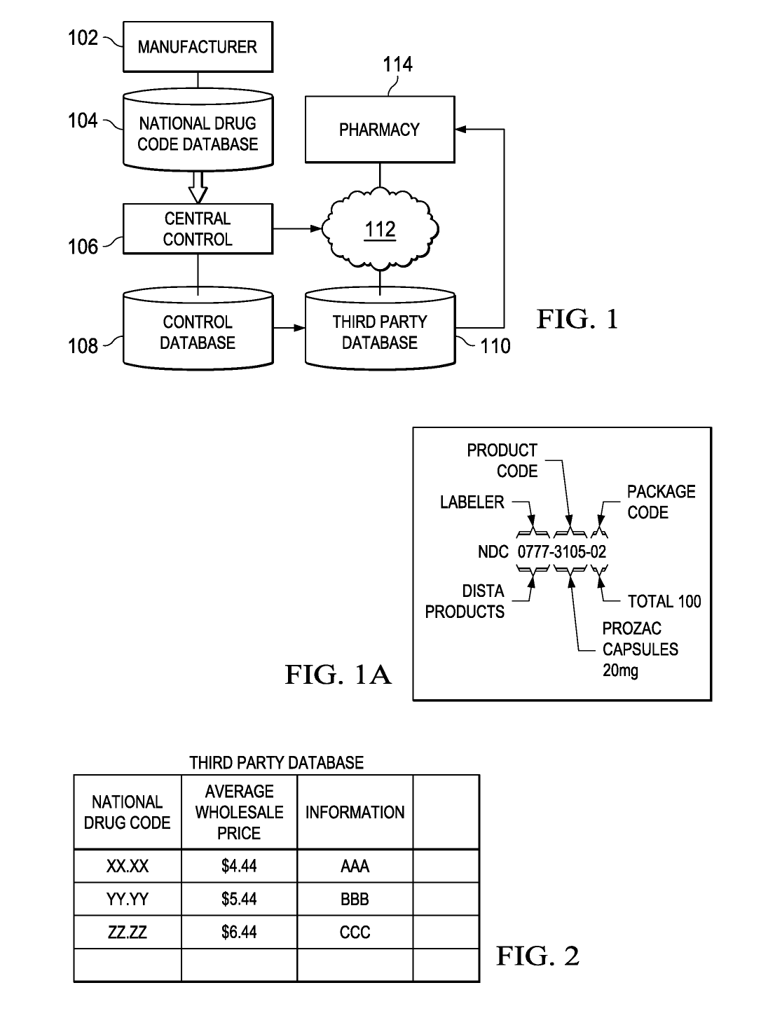

Referring now to FIG. 1, there is illustrated a diagrammatic view of the overall system for transferring NDCs between systems. The NDC, or National Drug Code, is a unique 10-digit, 3-segment number. It is a universal product identifier for human drugs in the United States. The code is present on all nonprescription (OTC) and prescription medication packages and inserts in the U.S. The 3 segments of the NDC identify the labeler, the product, and the commercial package size. The first set of numbers in the NDC identifies the labeler (manufacturer, repackager, or distributer). The second set of numbers is the product code, which identifies the specific strength, dosage form (i.e, capsule, tablet, liquid) and formulation of a drug for a specific manufacturer. Finally, the third set is the package code, which identifies package sizes and types. The labeler code is assigned by the FDA, while the product and package code are assigned by the labeler.

For example, the NDC for a 100-count bottle of Prozac 20 mg is 0777-3105-02. The first segment of numbers identifies the labeler. In this case, the labeler code “0777” is for Dista Products Company, the labeler of Prozac. The second segment, the product code, identifies the specific strength, dosage form (i.e, capsule, tablet, liquid) and formulation of a drug for a specific manufacturer. In our case, “3105” identifies that this dosage form is a capsule. The third segment is the package code, and it identifies package sizes and types. Our example shows that the package code “02” for this bottle of Prozac identifies that 100 capsules are in the bottle. The FDA maintains a searchable database of all NDC codes on their website. This is illustrated in FIG. 1A.

The NDC codes are unique codes that are applied for and assigned to specific individuals to be associated with specific products. Each manufacturer of allergens, for example, has a unique NDC associated with the allergen that they provide, which is assigned to that manufacture for that allergen based upon their applying for such. The manufacturer, therefore, has full ownership of that NDC. In order for that NDC to appear in a database with the associated information the approval of that manufacture is required. For example, manufacturer of a well-known drug will provide information to the database and populate that database and the record associated with that NDC with the information regarding that allergen associated with that NDC but they will also define what the AWP is for that allergen. It is the manufacturer, not the person that controls the NDC of the manufacturer, that controls what is in database, including the AWP. Additionally, it should be noted that a distributor could actually apply for an NDC and could populate or associate with that NDC information regarding a particular allergen. They could actually place this NDC that they own, this being a unique NDC, in a database with another NDC, a different and unique NDC, that will be associated with basically the same allergen. This, of course, would provide some NDC contention within the database which is to be avoided if possible. In addition, if a manufacturer were to expand their offerings such that bulk allergens were packaged in different bottles at different dosages, this would require an NDC code for that particular configuration. This, again, would be NDC codes that were owned by manufacturer and uniquely identify the particular allergen and the configuration and dosage of that allergen. Currently, allergens are distributed in bulk quantities.

Thus, a manufacturer 102 has associated there with its own proprietary database 104 to store their NDCs in association with information for that particular NDC. This can be provided to a central control center 106. The central control center 106 desires to have exclusive access to these NDCs of the manufacturer 102. This is the primary reason that these NDCs do not exist in any other database. Typically, the central control center 106 would have some type of contractual relationship with the manufacturer 102 for the purpose of maintaining some type of exclusivity with respect to the manufacturer's NDCs. Thereafter, these NDCs are stored in a central control database 108 at the central control center 106, in this database 108, the central control center 106 can modify and augment the information. Primarily, the main aspect that they add is the AWP, but they can reformat and reorganize the informative part of database associated with the particular allergen. This allows the central control 102 to thus control this AWP associated with each NDC of a particular manufacturer. There is, of course, the wholesale cost charged for the allergen to an end user such as a pharmacist, but the AWP is the benchmark price, again noting that the AWP is assigned to the NDC by recent control center 106 and not by the manufacture. This is not necessarily the price that the pharmacist, for example, will charge to the customer but, rather, it is the benchmark price. Further, this is not even the price that will be reimbursed to the pharmacist even if the pharmacist billed the customer for such. Thus, of course, this would not result in any type of price-fixing; rather, all that is controlled by the central control center 106 is the inclusion of AWP within the database. This AWP can be utilized by the reimbursing entities and the such for centering on a final reimbursement price.

With respect to the third-party database 110, this database is a database that can be accessed by both the pharmacist and the reimbursing entity such as the insurance companies. The pharmacist access this database 110 for the purpose of determining if the NDC for the particular prescribed allergen exists within the database. If so, then the pharmacist can access not only information about the allergen but also the AWP for that allergen. A claim can then be put in for the allergen with that NDC to, for example, the patient's insurer. The patient's insurer, when receiving acclaim, can access the database 110 to determine if this is in fact an NDC that exists in the database and has an AWP associated therewith. By having the AWP associated with the NDC, this allows the overall claim to be adjudicated.

The data associated with these allergens is then downloaded into a third party database 110 associated with a third-party information provider. This information provider is one of many information providers that provide access through a network 112 to a pharmacy 114. It is noted, however, that the central control 106 first confirms that none of the NDCs associated with any of the allergens is actually currently in the third party database 110. Once these NDCs and their associated information and associated AWPs are stored in the third party database 110 by the simple control center 106, the central control center 106 has some control over both the information and the AWP associated with each of the NDCs. Thus, when a pharmacist receives a request from a physician to fill a prescription for an allergen for delivery to the physician, the pharmacist can access the third party database 110 and determined that this is, in fact, in the database and is a reimbursable prescription. It is not the fact that the information merely exists in a database but, rather, that an AWP is associated there with that allows the claim made by the pharmacist to be adjudicated.

Referring now to FIG. 2, there is illustrated a diagrammatic view of the third party database 110 and a portion thereof populated by the central control center 106. This includes, in one column, NDCs for the various allergens, and a second column associated AWPs and in a third column information regarding the allergen associated with each of the NDCs. In a fourth column come there would be provided information regarding the source of the allergen associated with that NDC, that being the provider of the particular allergen. In the present disclosed embodiment, there is an exclusive arrangement between the central control center 106 and the manufacture such that no other distributor or entity is allowed to populate a third-party database with that NDC and with another AWP. As such, and insurer, when viewing the third-party database 110, will only be presented with a single AWP for a given NDC. There will thus be no conflict between one provider and another provider.

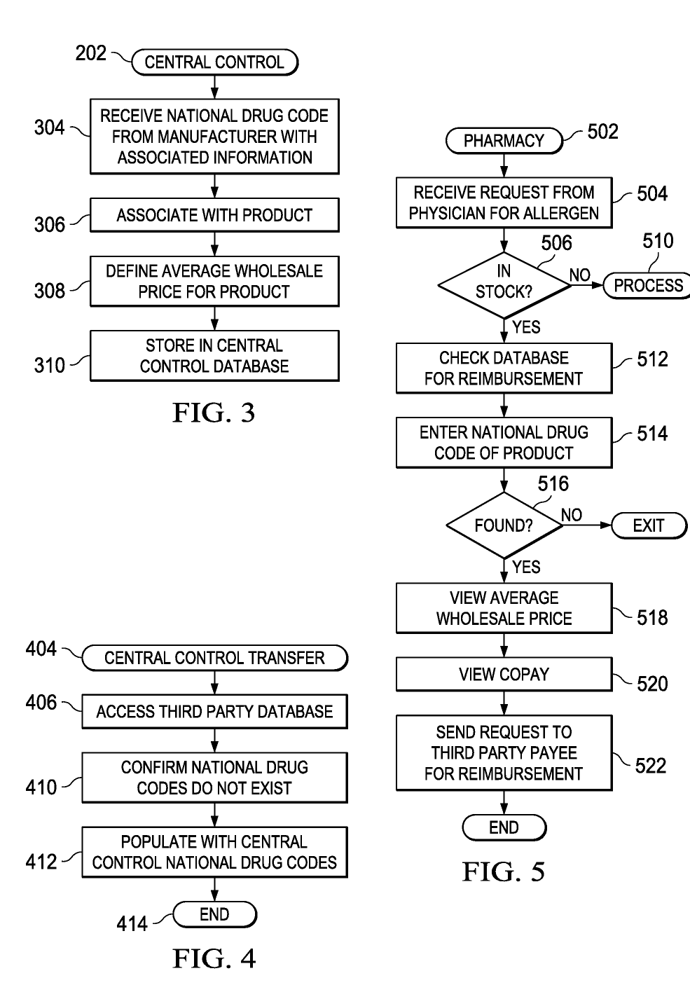

Referring now to FIG. 3, there is illustrated a flowchart depicting the initial operation of populating the database 108. The central control center 106 initiates the process at a block 202 and proceeds to block 304 in order to receive the NDC from the manufacturer for a particular allergen with the associated information regarding the associated allergen. This is one associated with allergen in the database of the central control center 106 and also with allergens controlled by the central control center 106. The central control center 106 is typically associated with some type of distribution center such that, with respect to the information that they associate with the NDC in the database 108, the control center 106 and the entity associated there with are the distribution arm for that allergen, i.e., this is where the allergen is ordered from by the pharmacist. The program then proceeds to a block 308 wherein the AWP for that particular allergen and associated with that NDC is defined by the central control center 106. This is a number that is set at whatever level is determined to be correct and appropriate by the central control center 106. There are a number of reasons for the price being set at any level. There is, of course, some cost of buying and allergen from the manufacturer 102, the markup and expenses associated with the operation of the central control center 106, resulting in a wholesale price to the pharmacist. This wholesale price is not necessarily associated with the record that is stored in the database 110. However, it is this information that is utilized in determining what the AWP will be for that NDC and associated allergen. A number of factors, of course, enter into that calculation, including practical knowledge of how the insurance industry reimburses for allergens. After processing, the information is stored in the central control database 108.

Referring now to FIG. 4, there is illustrated a flowchart depicting the transfer of data, which is initiated at a block 404 and then proceeds to a block 406 to access the third-party database 110 through the network 112. The program then flows to a function block 410 to confirm that no NDCs in the control database 108 exists within that third-party database 110 for the allergens that are desired to be populated within that third-party database 110, i.e., the manufacturer has not grant the right to another entity to populate that third-party database 110 nor had they done it without authorization. This will ensure that the central control center 106 has exclusive access for those particular NDCs associated with those particular allergens with respect to the third-party database 110. The program then flows to a function block 412 to populate the third-party database 110 with information from the control database 108, which, as described above, includes the information from the manufacturer, information regarding the central control center 106 as being a source of the allergen and the AWP for that allergen, all associated with the NDC assigned to the manufacturer for that allergen, this being a unique association between an NDC, information, the AWP and the provider of that AWP and allergen. The program that flows to a terminate block 414.

Once the third-party database 110 has been populated with the NDCs for the allergens from the central control center 106, this portion of the third-party database 110 will uniquely have all of the NDCs populated thereby directed to or pointed to or given a unique relationship with the central control center 106. The AWP is associated with each NDC but, this unique association of each NDC with the central control center 106 defines an ownership of that unique NDC by the central control center 106 and also uniquely defines the central control center 106 as the provider of the allergen(s) associated with that particular NDC or particular NDCs. By defining such a unique link, this allows the central control center 106 to be uniquely situated within the adjudication procedure or process with the insurer. Not only does the existence of the NDC for each of the allergens in the third-party database 110 provide the pharmacist with access to an AWP for that allergen the via the unique NDC and the insurer access to to such information also, but it also defines a unique link between all of those populated NDCs for the allergens to the central control center 106.

Referring now to FIG. 5, there is illustrated a flowchart for the operation at the pharmacy. This is initiated at a block 502 and then proceeds to a block 504 wherein the pharmacist receives a request from a physician for an allergen. This might actually be presented to the pharmacist by a patient which desires to receive the allergen for dilution and processing by the position or it may in fact be an already diluted allergen that could be actually self-administered by the patient. The program then flows to a decision block 506 to determine if the allergen is in stock. If the allergen is in stock, the program flows to a function block 512 to check the third-party database 110 for reimbursement and, if not, the program flows to a block 510 to process a stock item by whatever procedure the pharmacist utilizes. When checking the third-party database 110, the pharmacist enters the NDC code of the allergen, as indicated in a block 514. The program then flows to a decision block to determine if the NDC is found, this being block 516. If not found, the program exits and, if found, the program flows the function block 518 wherein the pharmacist can view the AWP for that allergen. This gives the pharmacist some idea as to what might be reimbursable in addition to the knowledge that this is in fact a reimbursable allergen, but also, the insurer itself can have access to third-party database 110 in order to provide information as to some type of potential co-pay. This just indicates the amount that the patient will pay at the counter. The pharmacist then can enter an amount that the pharmacist will claim that they want to be paid for this particular allergen, i.e., the claim that will be made to the insurer. It may be less than the AWP but not more than AWP. This, of course, is a function of what the pharmacist desires. This is indicated by block 520. Thus, there is provided a third-party database 110 heading information contained therein, which is controlled by the central control center 106 with respect to the allergens. Part of this is the AWP and part of it is the source for that allergen. The insurer has accents to this information and can utilize it to adjudicate a claim. Information from the insurer can be linked to this database indicating a co-pay, for example. With respect to this, and insurer can indicate that it will pay the entire cost of the particular allergen or indicate what percentage of the allergen that it will pay for. Sometimes, it is just a co-pay. However, for some very expensive allergens, the insurer may over time decide that it only pay a small percentage of the allergen. This will be on an allergen-by-allergen basis. By allowing this third-party database 110 to be controlled by the central control center 106 with respect to the cost for the particular allergen, this allows central control center 106 to control the adjudication of the particular allergen. The Program then flows to a function block to send a request to the third-party payee for reimbursement, as indicated by block 522.

The process for adjudicating any claim requires that some entity or party has worked with the insurance company or the reimbursing entity to negotiate the particular reimbursement or any benefits that are provided. If the pharmacist is apprised of an AWP in the database for a particular allergen, they at least have a price that they can charge for the product. For example, if the pharmacist has a product on the shelf with an NDC any position writes a prescription for that allergen, the pharmacist just needs to know how much to charge the patient. By accessing the third-party database 110, the AWP can be determined. However, that alone doesn't allow the pharmacist to determine whether benefits are associated with that particular allergen. In order to do that, there has to be some link between and an adjudicating party or entity. The pharmacist can select the NDC and a field (not shown) that directs the pharmacist to an adjudicating party or entity to provide information as to benefits that are available. If such indicates that benefits are available, then the armistice knows that they can make a claim to this adjudicating party.

In the current disclosed embodiment, the central control center 106 maintains the adjudicating database. The central control center 106 is responsible for interfacing with insurers and the such to provide these benefits. For example, if there are five major insurance companies that reimburse the pharmacist or even Medicare, the central control center 106 will make the arrangements for reimbursement and allow the pharmacist to determine whether the patient who may be associated with any of these reimbursement entities can receive benefits. If, for example, the patient had insurance with Insurer A, and central control center 106 had negotiated with Insurer A for certain benefits, this would be made available to the pharmacist. The benefits might provide for some type of co-pay which the pharmacist could charge to the patient and then the pharmacist could make a claim for the remaining value of the allergen to the adjudicating party, i.e., in this case the central control center 106. The central control center 106 would then process the claim and forward a check to the pharmacist. Since the central control center 106 populated the third-party database 110 with all of the NDCs, the central control center 106 has exclusive rights to adjudicate these NDCs and the associated allergens. Thus, this unique link from the third-party database 110 to the central control center 106 allows all claims to be adjudicated therethrough because the central control center 106 has exclusive control over these NDC for these allergens.

All of the NDCs, as noted hereinabove, or for allergens and allergens that are to be dispensed to a patient are a single dose allergen. Thus, each of the NDCs that would be obtained by the manufacturer would be for single dose allergens rather than bulk allergens that are currently provided.

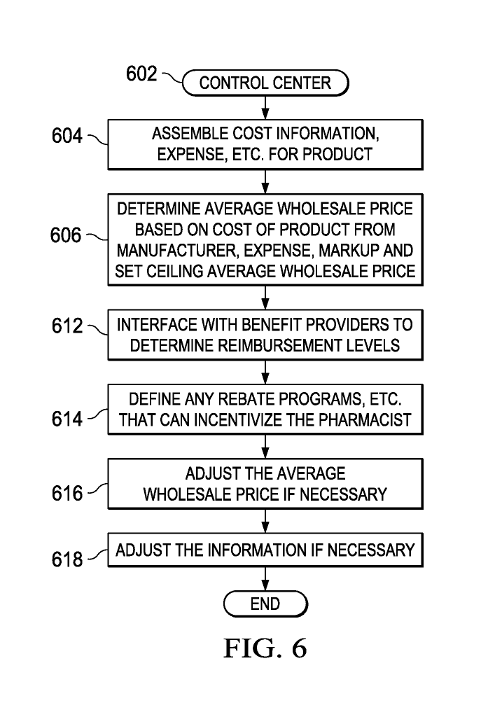

FIG. 6 illustrates a flow chart depicting the operation wherein the control center is able to determine the AWP by interfacing with the benefit providers. This is initiated at a block 602 and then proceeds to block 604 wherein the control center assembles the various cost information regarding the manufacturers cost to the control center, the expenses of storing the allergen at the control center, i.e., where the control center is the distributor and provider of the allergen, and what kind of markup or profit margin the control center expects to receive on a allergen. The program then flows a function block 606 to determine the AWP. This AWP is based on the information retrieved in block 604 and then a ceiling for the AWP is determined. This ceiling is a number that is arrived at by the control center based upon their knowledge of how the benefit providers reimburse pharmacists and the such. Since the AWP is a ceiling and the pharmacist cannot charge more than that, they provide a number that is a benchmark for the industry. By determining this benchmark, the insurance industry will typically center in on a lower reimbursable price, depending upon how valuable they think a particular allergen or the such is to the industry. For example, if they sold the product for $350 to the pharmacist, this being the wholesale price, they might set the AWP at $500. Over time, pharmacist may actually make a claim for only $450 which, at first, the insurance copies may reimburse. After a time, the insurance industry may come to the conclusion that this allergen is only reimbursable at a rate of $400.

The program then flows to a function block 612 wherein a control center can interface with benefit providers to determine what the reimbursement levels are and, if necessary, adjust the AWP. However, they can also determine such things as rebate programs and incentives and the such that they can provide to the pharmacist, as indicated by a function block 614. Since they control the database they can also write information from the interface with that particular part of the database. Program then flows to a function block 616 to adjust the AWP if necessary and into a function block 618 to adjust the information in the database if necessary.

Although the preferred embodiment has been described in detail, it should be understood that various changes, substitutions and alterations can be made therein without departing from the spirit and scope of the invention as defined by the appended claims.

What is claimed is:

1. A method for adjudicating reimbursement for allergens between a pharmacist and a reimbursing entity, comprising:
obtaining at a central control center National Drug Codes (NDC's) for a plurality of allergens, each of the allergens being a single dose single use allergen for a patient and each NDC uniquely identifying that particular allergen as to its manufacture, the particular allergen, the packaging and the dosage, and further obtaining information as to a description of the particular allergen, dosage and manufacture;
determining by the central control center an Average Wholesale Price (AWP) for each of the allergens associated with each of the NDC's;
storing in a central control database the obtained NDC's in association with an associated AWP and associated information for the allergen;
accessing a third-party database accessible by a pharmacist and determining if any of the NDC's in the central control database are contained within the third-party database and, if not:
transferring the associated NDC's not in the third-party database and that exist in the central control database for each of the allergens to the third-party database in association with the AWP and associated information for each of the allergens for each of the NDC's, and
uniquely associating each of the NDC's in the third-party database to the central control center for adjudication information; and
creating an adjudicating database at the central control center having defined benefits associated with reimbursable entities for each of the NDC's stored in the third-party database and in the central control database, wherein a pharmacist can access this information by accessing a particular NDC in the third-party database to obtain information regarding reimbursable benefits from the central control center and enter a claim with the central control center for adjudication and wherein the central control center is able to process any claim made by the pharmacist and reimburse the pharmacist accordingly.
